(19) United States
(12) Patent Application Publication
(10) Pub. No.: US 2013/0236746 A1
(43) Pub. Date: Sep. 12, 2013

(54) Method and apparatus for electric batteries including nano-components

(71) Applicant: Yuda Gabai, Moshav Beet Elaazari (IL)

(72) Inventor: Yuda Gabai, Moshav Beet Elaazari (IL)

(21) Appl. No.: 13/417,277

(22) Filed: Mar. 11, 2012

(51) Int. Cl. H01M 6/02; H01M 10/02

(52) U.S. Cl. 429/50; 429/122

(57) ABSTRACT

The present invention innovates method and an apparatus of a nano-components electric batteries, fitted to produce an electric energy, wherein, the method and an electric batteries of the present invention enables to combine in the electric batteries some components which had treated in some prior process, such process designated to transform some materials by a nanotechnology transforming materials and components process to a nano-components and materials, fitted to be combined as nano-components and materials with some parts of the electric batteries, and all together performing an electric batteries as in the present invention method and apparatus.

### BACKGROUND OF THE INVENTION

The current invention is at the field of electric energy produces from electric batteries. More particularly, the invention relates to method and apparatus of nano-components electric batteries, designated to produce a higher production and output of an electric energy, and to enables a longer period of time operation of electrical devices and systems, or for a smaller and light-weight batteries, for improving electric vehicle operational abilities for example, or for improving electric devices and system operation abilities.

Electric energy produces by an electric batteries is one of the main energy sources which operating electric devices and system all over the world. There are some archeological findings, even from ancient Egypt period of time, of basic electrical batteries made from ceramic jug, some acid liquids, and an Anode and Cathode putted inside the acid from one side and from their other side connected with conductive electricity wires, for example, to the electric device and electric consumer, for the purposes of electricity production and electric consumer operation.

These days, electric energy from electrical batteries enabled by, “solid batteries”, and by batteries type such of those used for example in motorized vehicles, which some of them includes liquid acid.

Conventional automobile batteries, for example, include a fairly standard sized rectangular casing inside, for example, of which are positioned cells (six for 12 volt batteries, three for 6 volt batteries for example). The cells each contain positive and negative battery plates and appropriate electrolytic fluid to allow the battery to produce, store, and recharge electrical power. The operation of a conventional battery is well known within the art and will not be explained further at this point. Normal automobile batteries are rated between approximately 300 amps cranking power for the weakest batteries up to 800 or 900 amps for the most powerful.

Conventional battery technology has improved considerably in the last decades. Conventionally sized automobile batteries have increased power, increased life, better response to discharge and recharge, and less maintenance than predecessors. This allows improved starting, as well prolonged operation of electrical equipment and auxiliary equipment with the automobile battery.

A significant problem still exists, however. If for any reason the conventional automobile battery loses power, or is discharged, the needed source for electrical power is lost. There are no alternatives other than to jump start the automobile or to restore, or replace the battery.

The examples of situations where this scenario occurs are legion. If automobile lights are left on for extended periods of time without the car running, discharge of the battery is inevitable. If other auxiliary equipment such as radios, fans, or the like is left on without the engine running, similar problems can occur. Electrical shorts, or bad connections to the battery, may cause that it does not recharge during use, where failure of the battery leaves the vehicle basically helpless.

Other problems that come with reliance on a single battery are well known. Despite these problems, conventional batteries are almost universally utilized. Some attempts have been made to solve this problem but none have been accepted or apparently are satisfactory.

One example is the mounting of two or more conventional batteries in one automobile. When reserve power is needed, the second battery can be connected into the electrical system.

The problems with this system are very clear cut. The system doubles, or more than doubles the cost for battery power, utilizes twice the space, which many times precludes such a system being used, and requires additional needed hardware, such as connecting wiring, switches, and additional mounting structure.

The Baumheckel, Warren, Draper and Stroud patents utilize two separate batteries which are interconnected or switchable. Thiess describes a portable reserve battery canister which can be plugged into the automobile's electrical system through the cigarette lighter plug.

However, especially, the new approach of the increases in production and consuming an electrical vehicle at the last few years, see the electrical batteries development as the main task of that industries, and make the electrical batteries of those vehicles essential to that type of vehicle, and even to the hybrid type of vehicle, wherein, the main limitation of the electrical vehicle is because of the electrical battery limited power supply, which lives those vehicles in their most grave disadvantage compared to the vehicular types using fluid fuel, or the gas operated vehicles type for example. Wherein, the main disadvantage is due to the limited “route length” the electrical vehicle can provide until the batteries has to be recharge, or to be replaced, as the electrical battery is the main power of the electric vehicle. Wherein, solutions of multiple batteries, and even those of the “multiple solid batteries” to solve this problem are limited too, for the space it required, its size and weight, and their high costs.

New technologies developed in the last years, enabling to develop a new and a better electric batteries then some of these existing in the prior-art, such technology which fitted to develop a new type of electrical batteries, which presented in the present invention method and apparatus, are the nanotechnology process that enable a production of nano-particles from different materials by different process, such as by “top-down” method, in this method a force is activated upon some material for crush the material particles to a nanometers size. Another nanotechnology process that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size. Wherein, such process enabling a better electrical conductivity and a higher flow of electrons.

Wherein, the present invention method and apparatus renewing in electrical batteries by process that transform some of the batteries components and materials to “nano-particles”, wherein, some of the batteries components and materials that can be transformed to “nano-particles” are: the batteries components and materials that by changing them to “nano-particles” the flow of electrons between the batteries components and materials will increase, or the conductivity will be a better conductivity, or the absorption or the release of electrons between the batteries components and materials will increase, for some examples: some of the batteries components and materials that can be transformed to “nano-particles” by the method and the an electric batteries of the present invention are: the acid, the Ionic liquid, the components and materials that embodies the Anode, the positive pole; the Cathode, the negative pole; components and materials that influencing and enabling the flow of electrons between the batteries components and materials.

The present invention by its method and an apparatus of such nano-components electric batteries, designated to produce a higher production and output of an electrical energy, or to enables a longer time of continual operation of an electrical devices that use its electricity for operation, or for a smaller and light-weight batteries, these are some of the significant advantages over the existing prior arts batteries. Furthermore, the present invention by its method and an electric batteries of such nano-components electric batteries, designated to be applied in all the implementations that are using electrical batteries, and even for implementations in the prior-art that does not using electrical batteries, for example for use for electric consumers: devices and systems; for vehicles; for providing electricity to building and houses; for electrical vehicle for example, enabling for example for an electrical vehicle to preforms more kilometer of constant driving before charging, or replacing the batteries, comparison to the existing batteries enabling 120 kilometer, wherein, for example, this is the difference between a sufficient to a nun-sufficient performance of the batteries, from the vehicle driver point of view.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention innovates method and an apparatus of an electric batteries, producing an electric energy, wherein, the method and the electric batteries, enabling a producing of an electric current flow from the electrical batteries, or enabling a higher production and output of an electrical energy, or enabling a longer time of continual operation of an electrical devices, or enabling a smaller and light-weight batteries, for some electrical consumer and devices and systems, before needed to be recharged, wherein, such method comprising:

Production of an electric batteries in a process of technologies developed in the lest years, such technology which are fitted to develop a new type of electrical batteries, which presented in the present invention method and an electric batteries, is the “nanotechnology process”, wherein, the “nanotechnology process” enable a production of “nano-particles” from different materials by different process, such as by “top-down” method, in this method a force is activated upon some material for crush the material particles to a nanometers size. Another “nanotechnology process” that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size. Wherein, such process enabling a “nano-particles” which have a better electrical conductivity and a higher flow of electrons.

Wherein, the present invention method and the apparatus, enabling the production of electrical batteries by some process that transform some of the batteries components and materials to “nano-particles”, wherein, some of the batteries components and materials that enabled to be transformed to “nano-particles” are: the batteries components and materials that by changing them to “nano-particles”, the flow of electrons between the batteries components and materials is increase compared to the flow of the electrons before changing them, or the conductivity will be a better conductivity, or the Absorption or the release of electrons between the batteries components and materials will increase, for some example: some of the batteries components and materials that can be transformed to “nano-particles” by the method of the present invention are: the acid, the Ionic liquid, the components and materials that embodies the Anode, the positive pole; the Cathode, the negative pole; components and materials that influencing and enabling the flow of electrons between the batteries components and materials.

Wherein, such method enables the production of electrical batteries, and electric batteries in a variety of different implementations. Wherein, such method and apparatus enabled in all batteries types, “Dry Batteries” and “liquid type Batteries”.

Wherein, such method and batteries enabling the transformation of components and materials in the batteries to a “nano-particles” by a prior production or by a process enabled in the batteries, or at the batteries surroundings, optionally by the proper mechanism and systems.

### BRIEF DESCRIPTION OF THE DRAWINGS

The added drawings in this patent request come in order to provide more visual understandings about the invention and are integral part of the request and the invention. The drawings describe different functions of the invention and, added to all the mentioned above, serve the purpose of explaining the principles and ways of operation and not, by any means, suppose to limit the invention solely to them.

FIG. 1 is a schematic description of flowchart of some of the method enabling to perform an electric batteries with “nano-particles”, enabled in the method and the electric batteries of the present invention.

FIG. 2 is a schematic description that shows an example of an implementation, included in the current invention, enabled an apparatus of electric batteries with “nano-particles” as in the present invention.

FIG. 3 is a schematic description that shows an example of an implementation, included in the current invention, enabled an apparatus of electric batteries with “nano-particles” as in the present invention.

### DESCRIPTION OF THE PREFERRED EMBODIMENTS

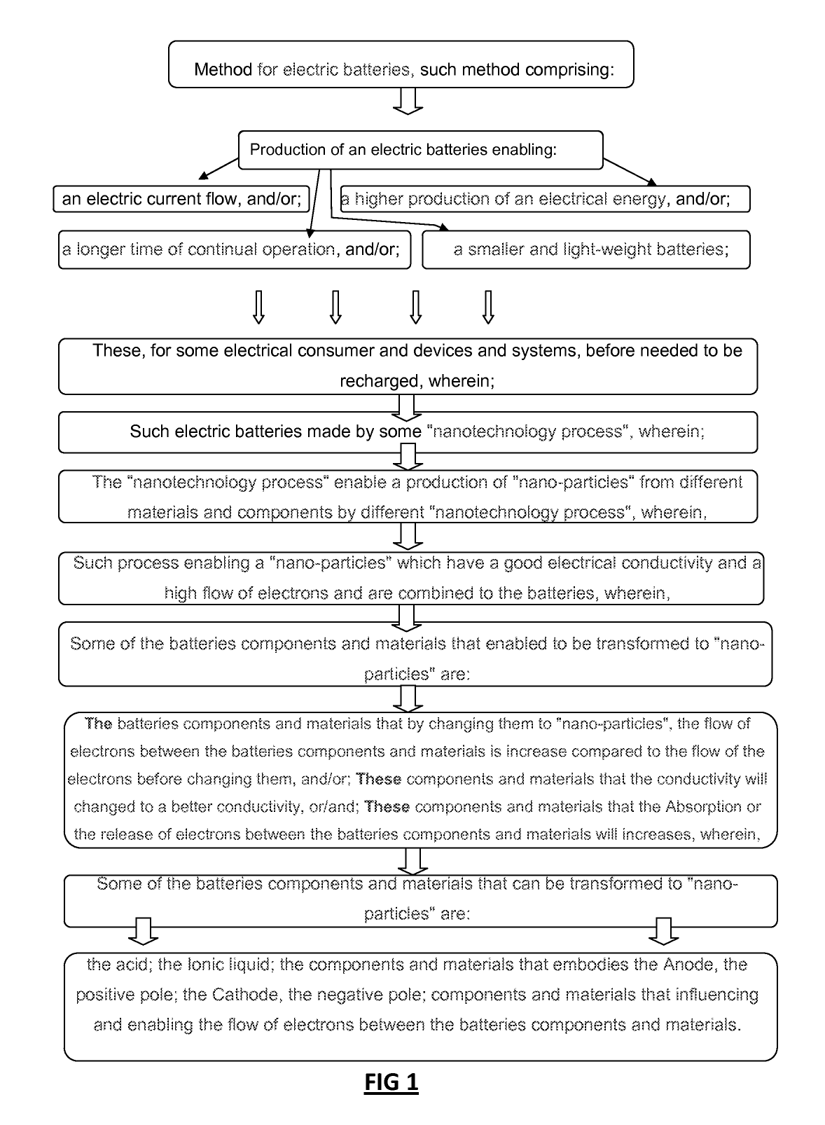

FIG. 1 is a schematic description of flowchart of some of the method enabling to perform an electric batteries with “nano-particles”, enabled in the method and the electric batteries of the present invention, wherein the method comprising:
a. producing of an electric batteries enabling an electric current flow, wherein;
b. such electric batteries enabling a high production and output of an electrical energy, or enabling a long time of continual operation of an electrical devices, or enabling a small and light-weight batteries, for some electrical consumer and devices and systems, before needed to be recharged, wherein;
c. such production of an electric batteries made by some process of the “nanotechnology process”, wherein;
d. the “nanotechnology process” enable a production of “nano-particles” from different materials and components by different “nanotechnology process”, wherein;
e. some of the “nanotechnology process” available for example is: by “top-down” method, in this method a force is activated upon some material for crush the material particles to a nanometers size. Another “nanotechnology process” that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size, Wherein;
f. such process enabling a “nano-particles” which have a good electrical conductivity and a high flow of electrons, wherein,
g. production of electrical batteries by some process that transform some of the batteries components and materials to “nano-particles”, wherein,
h. some of the batteries components and materials that enabled to be transformed to “nano-particles” are: the batteries components and materials that by changing them to “nano-particles”, the flow of electrons between the batteries components and materials is increase compared to the flow of the electrons before changing them, or the conductivity will be a better conductivity, or the absorption or the release of electrons between the batteries components and materials will increases, wherein,
i. for some example: some of the batteries components and materials that can be transformed to “nano-particles” by the method and the apparatus of the present invention are: the acid; the Ionic liquid; the components and materials that embodies the Anode, the positive pole; the Cathode, the negative pole; components and materials that influencing and enabling the flow of electrons between the batteries components and materials.

Wherein, such method designated to enable the production of an electric batteries and apparatus in different implementations.

Wherein, such method and apparatus enabled in all batteries types, “Dry Batteries” and “liquid type Batteries”.

Wherein, such method and apparatus enabled in batteries enabling the transformation of components and materials in the batteries to a “nano-particles” by a prior production, or by a process enabled in the batteries, or at the batteries surroundings, optionally by the proper systems.

Wherein such electric batteries with “nano-particles” as in the present invention have implementations fitted to electrical consumers devices and system such as to vehicles, electric vehicles, hybrid vehicles, air and sea transportation devices and vehicles, building and houses, etc.

Wherein such electric batteries with “nano-particles” as in the present invention have implementations fitted to electrical consumers devices and system that uses small size batteries, such as a 1.5 up to 24 volt.

wherein such electric batteries with “nano-particles” as in the present invention have implementations fitted to electrical consumers devices and system that uses electricity from 24 volt up to 230 volt, and from 230 volt to a higher volt consumption, this by the batteries of the present invention, and optional by the batteries of the present invention which connected to a convertor that convert the batteries electricity to 110 volt up to 230 volt for house and buildings needs.

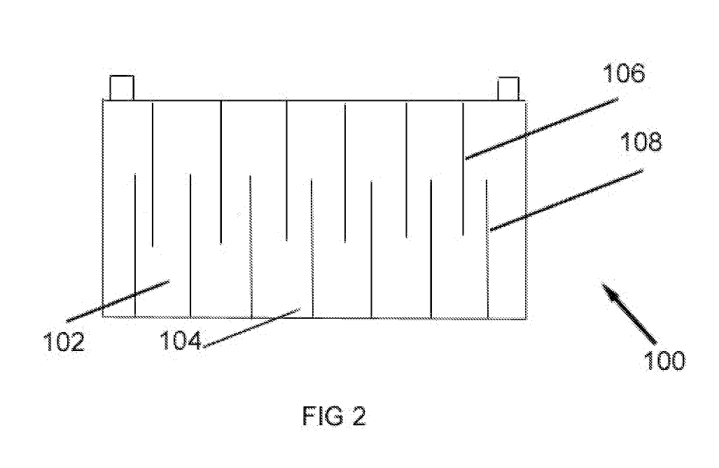

FIG. 2 is a schematic description that shows an example of an implementation 100, included in the current invention, enable an apparatus of electric battery 100 with “nano-particles” as in the present invention, wherein, some of the components and materials of the battery 100 can be components and materials that produces by some nanotechnology process prior to the battery 100 assembled from all its parts, wherein, some of the batteries components and materials that are from “nano-particles” by the method and the apparatus of the present invention are: the acid 102; the optional Ionic liquid 104; the components and materials that embodies the Anode, the positive pole 106; the Cathode, the negative pole 108; and another components and materials that influencing and enabling the flow of electrons between the batteries components and materials.

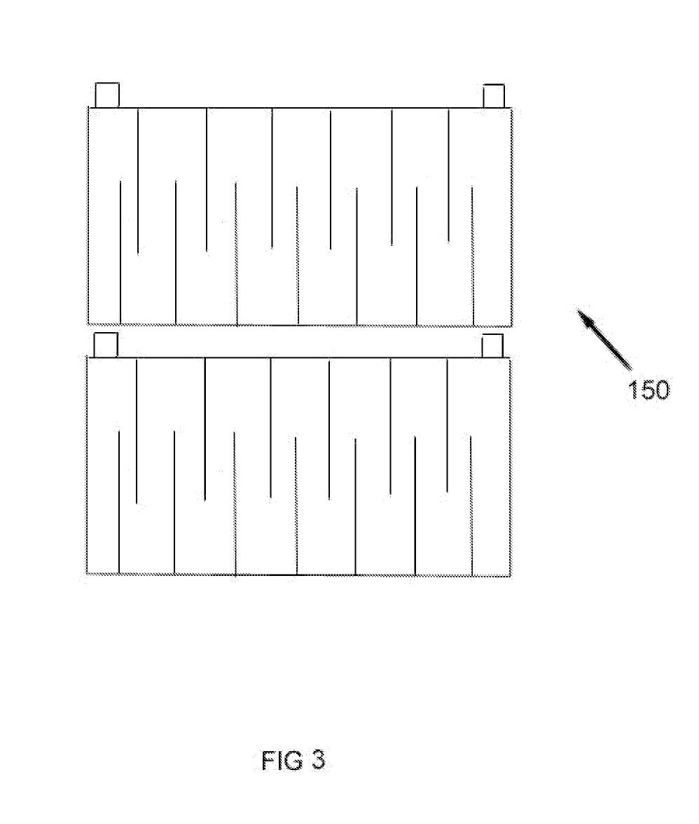

FIG. 3 is a schematic description that shows an example of an implementation 150, included in the current invention, enable an apparatus of electric batteries 150 with “nano-particles” as in the present invention, wherein, such electric batteries 150 connected to each other forming a group of at list two batteries, enabling a longer period of continual production of electricity flow, or a higher power, wherein, optionally such group of electric batteries can be connected and operated by system that operates some of the group batteries when other batteries are disconnected by the system for their inability to continue to produce electric current.

1. Method for an electric batteries producing an electric energy, wherein, the method enabling a producing of an electric current flow from the electrical batteries, wherein, such method comprising:
a. Production of an electric batteries enabling an electric current flow, or electric batteries enabling a higher production and output of an electrical energy, or enabling a longer time of continual operation of an electrical devices, or enabling a smaller and light-weight batteries, for some electrical consumer and devices and systems, before needed to be recharged, wherein;
b. such production of an electric batteries made by some process exists in the “nanotechnology process”, wherein;
c. the “nanotechnology process” enable a production of “nano-particles” from different materials and components by different “nanotechnology process”, wherein;
d. such process enabling a “nano-particles” which have a good electrical conductivity and a high flow of electrons, wherein,
e. the production of the electrical batteries made by some of the process that transform some of the batteries components and materials to “nano-particles”, wherein;
f. some of the batteries components and materials that enabled to be transformed to “nano-particles” are: the batteries components and materials that by changing them to “nano-particles”, the flow of electrons between the batteries components and materials is increase compared to the flow of the electrons before changing them; or these components and materials that the conductivity will changed to a better conductivity; or these components and materials that the Absorption or the release of electrons between the batteries components and materials will increases, wherein;
g. some of the batteries components and materials that can be transformed to “nano-particles” by the method and the apparatus of the present invention are: the acid; the Ionic liquid; the components and materials that embodies the Anode, the positive pole; the Cathode, the negative pole; components and materials that influencing and enabling the flow of electrons between the batteries components and materials.

2. Method as in claim 1, wherein some of the “nanotechnology process” available in the present method for examples are: by “top-down” method, in this method a force is activated upon some material for crush the material particles to a nanometers size, wherein, another “nanotechnology process” that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size.

3. Method as in claim 1, wherein such method enabling the production of an electrical batteries and apparatus in a varieties of implementations.

4. Method as in claim 1, wherein some of the “nanotechnology particles” in the present method enabled in all batteries types, “Dry Batteries” and “liquid type Batteries”.

5. Method as in claim 1, wherein some of the “nanotechnology particles” in the batteries enabling the transformation of components and materials in the batteries to a “nano-particles” in a prior production, or by a process enabled in the batteries, or at the batteries surroundings, by the proper systems.

6. The method of claim 1, wherein such electric batteries with “nano-particles” as in the present invention, connected to each other forming a group of at list two batteries, enabling a longer period of continual production of electricity flow, or a higher electricity power, wherein, optionally such group of electric batteries can be connected and operated by system that operates some of the group batteries, when other batteries are disconnected by the system for their inability to continue to produce electric current.

7. The method of claim 1, wherein such electric batteries with “nano-particles” as in the present invention have implementations fitted to electrical consumers devices and system such as to vehicles, electric vehicles, hybrid vehicles, air and sea transportation devices and vehicles, building and houses, etc.

8. The method of claim 1, wherein such electric batteries with “nano-particles” as in the present invention have implementations fitted to electrical consumers devices and system that uses small size batteries, such as a 1.5 up to 24 volt.

9. The method of claim 1, wherein such electric batteries with “nano-particles” as in the present invention have implementations fitted to electrical consumers devices and system that uses electricity from 24 volt up to 230 volt, and from 230 volt to a higher volt consumption, this by the batteries of the present invention, and optional by the batteries of the present invention which connected to a convertor that convert the batteries electricity to 110 volt up to 230 volt for houses and buildings needs.

10. An electric batteries producing an electric energy, wherein, the electric batteries enabling a producing of an electric current flow from the electrical batteries, or enabling a higher production and output of an electrical energy, or enabling a longer time of continual operation of an electrical devices and systems, or enabling a smaller and light-weight batteries, for some electrical consumer and devices and systems, before needed to be recharged, wherein, such an electric batteries comprising:
a. production of the electric batteries made by some process exists in the “nanotechnology process”, wherein;
b. the “nanotechnology process” enable a production of “nano-particles” from different materials and components by different “nanotechnology process”, wherein;
c. such process enabling a “nano-particles” which have a good electrical conductivity and a high flow of electrons, wherein;
d. the production of the electrical batteries made by some of the process that transform some of the batteries components and materials to “nano-particles”, wherein;
e. some of the batteries components and materials that enabled to be transformed to “nano-particles” are: the batteries components and materials that by changing them to “nano-particles”, the flow of electrons between the batteries components and materials is increase compared to the flow of the electrons before changing them; or these components and materials that the conductivity will changed to a better conductivity; or these components and materials that the Absorption or the release of electrons between the batteries components and materials will increases, wherein;
f. some of the batteries components and materials that can be transformed to “nano-particles” by the method and the apparatus of the present invention are: the add; the Ionic liquid; the components and materials that embodies the Anode, the positive pole; the Cathode, the negative pole; components and materials that influencing and enabling the flow of electrons between the batteries components and materials;

11. An electric batteries as in claim 10, wherein some of the “nanotechnology process” available in the present electric batteries for examples are; by “top-down” method, in this method a force is activated upon some material for crush the material particles to a nanometers size, wherein, another “nanotechnology process” that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size.

12. Electric batteries as in claim 10, wherein such method enabling the production of an electrical batteries and an in a varieties of implementations.

13. Electric batteries as in claim 10, wherein some of the “nanotechnology particles” in the present electric batteries enabled in all batteries types, “Dry Batteries” and “liquid type Batteries”.

14. Electric batteries as in claim 10, wherein some of the “nanotechnology particles” in the batteries enabling the transformation of components and materials in the batteries to a “nano-particles” in a prior production, or by a process enabled in the batteries, or at the batteries surroundings, by the proper systems.

15. Electric batteries of claim 10, wherein such electric batteries with “nano-particles” as in the present invention, connected to each other forming a group of at list two batteries, enabling a longer period of continual production of electricity flow, or a higher electricity power, wherein, optionally such group of electric batteries can be connected and operated by system that operates some of the group batteries, when other batteries are disconnected by the system for their inability to continue to produce electric current.

16. Electric batteries of claim 10, wherein such electric batteries with “nano-particles” as in the present invention have implementations fitted to electrical consumers devices and system such as to vehicles, electric vehicles, hybrid vehicles, air and sea transportation devices and vehicles, building and houses, etc.

17. Electric batteries of claim 10, wherein such electric batteries with “nano-particles” as in the present invention have implementations fitted to electrical consumers devices and system that uses small size batteries, such as a 1.5 up to 24 volt.

18. Electric batteries of claim 10, wherein such electric batteries with “nano-particles” as in the present invention have implementations fitted to electrical consumers devices and system that uses electricity from 24 volt up to 230 volt, and from 230 volt to a higher volt consumption, this by the batteries of the present invention, and optional by the batteries of the present invention which connected to a convertor that convert the batteries electricity to 110 volt up to 230 volt for house and buildings needs.
